(19) United States
(12) Patent Application Publication
(10) Pub. No.: US 2012/0224043 A1
(43) Pub. Date: Sep. 6, 2012

(54) INFORMATION PROCESSING APPARATUS, INFORMATION PROCESSING METHOD, AND PROGRAM

(75) Inventor: Shingo Tsurumi, Saitama (JP)

(73) Assignee: Sony Corporation, Tokyo (JP)

(21) Appl. No.: 13/364,755

(22) Filed: Feb. 2, 2012

(30) Foreign Application Priority Data
Mar. 4, 2011 (JP) 2011-047892

(51) Int. Cl. H04N 7/18

(52) U.S. Cl. 348/78; 348/77; 348/E07.085

(57) ABSTRACT

Provided is an information processing apparatus including an image acquisition unit for acquiring an image of a user positioned near a display unit on which video of content is displayed, a viewing state determination unit for determining a viewing state, of the user, of the content based on the image, and an audio output control unit for controlling output of audio of the content to the user according to the viewing state.

### BACKGROUND

The present disclosure relates to an information processing apparatus, an information processing method, and a program.

Display devices such as TVs are installed at various places such as living rooms, rooms and the like in homes, and provide video and audio of content to users in various aspects of life. Therefore, the viewing states, of users, of content that is provided also vary greatly. Users do not necessarily concentrate on viewing content, but may view content while studying or reading, for example. Accordingly, a technology of controlling playback property of video or audio of content according to the viewing state, of a user, of content is being developed. For example, JP 2004-312401A describes a technology of determining a user's level of interest in content by detecting the line of sight of the user and changing the output property of the video or audio of content according to the determination result.

### SUMMARY

However, the viewing state, of a user, of content is becoming more and more varied. Thus, the technology described in JP 2004-312401A does not sufficiently output content that is in accordance with various needs of a user in each viewing state.

Accordingly, a technology of controlling output of content, responding more precisely to the needs of a user in each viewing state, is desired.

According to the present disclosure, there is provided an information processing apparatus which includes an image acquisition unit for acquiring an image of a user positioned near a display unit on which video of content is displayed, a viewing state determination unit for determining a viewing state, of the user, of the content based on the image, and an audio output control unit for controlling output of audio of the content to the user according to the viewing state.

Furthermore, according to the present disclosure, there is provided an information processing method which includes acquiring an image of a user positioned near a display unit on which video of content is displayed, determining a viewing state, of the user, of the content based on the image, and controlling output of audio of the content to the user according to the viewing state.

Furthermore, according to the present disclosure, there is provided a program for causing a computer to operate as an image acquisition unit for acquiring an image of a user positioned near a display unit on which video of content is displayed, a viewing state determination unit for determining a viewing state, of the user, of the content based on the image, and an audio output control unit for controlling output of audio of the content to the user according to the viewing state.

According to the present disclosure described above, the viewing state, of a user, of content is reflected in the output control of audio of content, for example.

According to the present disclosure, output of content can be controlled more precisely in accordance with the needs of a user for each viewing state.

### BRIEF DESCRIPTION OF THE DRAWINGS

FIG. 1 is a block diagram showing a functional configuration of an information processing apparatus according to an embodiment of the present disclosure;

FIG. 2 is a block diagram showing a functional configuration of an image processing unit of an information processing apparatus according to an embodiment of the present disclosure;

FIG. 3 is a block diagram showing a functional configuration of a sound processing unit of an information processing apparatus according to an embodiment of the present disclosure;

FIG. 4 is a block diagram showing a functional configuration of a content analysis unit of an information processing apparatus according to an embodiment of the present disclosure;

FIG. 5 is a flow chart showing an example of processing according to an embodiment of the present disclosure; and

FIG. 6 is a block diagram showing a hardware configuration of an information processing apparatus according to an embodiment of the present disclosure.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and configuration are denoted with the same reference numerals, and repeated explanation of these structural elements is omitted.

Additionally, the explanation will be given in the following order.

1. Functional Configuration

2. Process Flow

3. Hardware Configuration

4. Summary

5. Supplement

(1. Functional Configuration)

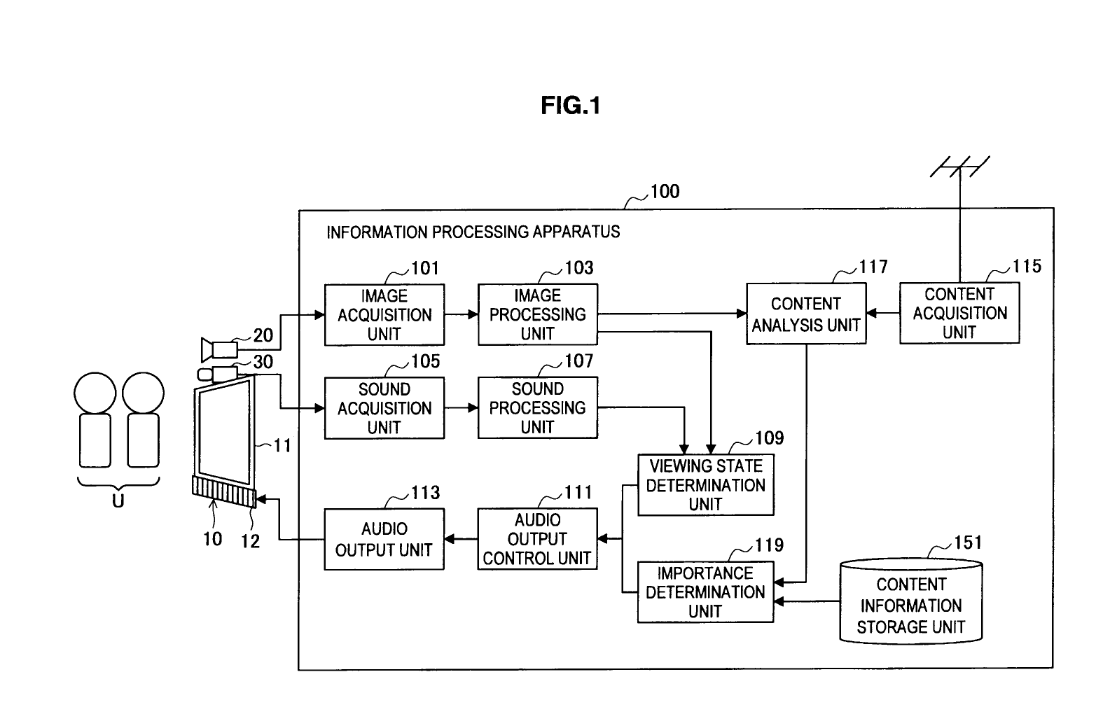

First, a schematic functional configuration of an information processing apparatus 100 according to an embodiment of the present disclosure will be described with reference to FIG. 1. FIG. 1 is a block diagram showing a functional configuration of the information processing apparatus 100.

The information processing apparatus 100 includes an image acquisition unit 101, an image processing unit 103, a sound acquisition unit 105, a sound processing unit 107, a viewing state determination unit 109, an audio output control unit 111, an audio output unit 113, a content acquisition unit 115, a content analysis unit 117, an importance determination unit 119 and a content information storage unit 151. The information processing apparatus 100 is realized as a TV tuner or a PC (Personal Computer), for example. A display device 10, a camera 20 and a microphone 30 are connected to the information processing apparatus 100. The display device 10 includes a display unit 11 on which video of content is displayed, and a speaker 12 from which audio of content is output. The information processing apparatus 100 may be a TV receiver or a PC, for example, that is integrally formed with these devices. Additionally, parts to which known structures for content playback, such as a structure for providing video data of content to the display unit 11 of the display device 10, can be applied are omitted in the drawing.

The image acquisition unit 101 is realized by a CPU (Central Processing Unit), a ROM (Read Only Memory), a RAM (Random Access Memory) and a communication device, for example. The image acquisition unit 101 acquires an image of a user U near the display unit 11 of the display device 10 from the camera 20 connected to the information processing apparatus 100. Additionally, there may be several users as shown in the drawing or there may be one user. The image acquisition unit 101 provides information on the acquired image to the image processing unit 103.

The image processing unit 103 is realized by a CPU, a GPU (Graphics Processing Unit), a ROM and a RAM, for example. The image processing unit 103 processes the information on the image acquired from the image acquisition unit 101 by filtering or the like, and acquires information regarding the user U. For example, the image processing unit 103 acquires, from the image, information on the angle of the face of the user U, opening and closing of the mouth, opening and closing of the eyes, gaze direction, position, posture and the like. Also, the image processing unit 103 may recognize the user U based on an image of a face included in the image, and may acquire a user ID. The image processing unit 103 provides these pieces of information which have been acquired to the viewing state determination unit 109 and the content analysis unit 117. Additionally, a detailed functional configuration of the image processing unit 103 will be described later.

The sound acquisition unit 105 is realized by a CPU, a ROM, a RAM and a communication device, for example. The sound acquisition unit 105 acquires a sound uttered by the user U from the microphone 30 connected to the information processing apparatus 100. The sound acquisition unit 105 provides information on the acquired sound to the sound processing unit 107.

The sound processing unit 107 is realized by a CPU, a ROM and a RAM, for example. The sound processing unit 107 processes the information on the sound acquired from the sound acquisition unit 105 by filtering or the like, and acquires information regarding the sound uttered by the user U. For example, if the sound is due to an utterance of the user U, the sound processing unit 107 performs estimation suggesting the user U, who is the speaker, and acquires a user ID. Furthermore, the sound processing unit 107 may also acquire, from the sound, information on the direction of the sound source, presence/absence of an utterance, and the like. The sound processing unit 107 provides these pieces of acquired information to the viewing state determination unit 109. Additionally, a detailed functional configuration of the sound processing unit 107 will be described later.

The viewing state determination unit 109 is realized by a CPU, a ROM and a RAM, for example. The viewing state determination unit 109 determines the viewing state, of the user U, of content, based on a movement of the user U. The movement of the user U is determined based on the information acquired from the image processing unit 103 or the sound processing unit 107. The movement of the user includes “watching video,” “keeping eyes closed,” “mouth is moving as if engaged in conversation,” “uttering” and the like. The viewing state of the user that is determined based on such a movement of the user is “viewing in normal manner,” “sleeping,” “engaged in conversation,” “on the phone,” “working” or the like, for example. The viewing state determination unit 109 provides information on the determined viewing state to the audio output control unit 111.

The audio output control unit 111 is realized by a CPU, a DSP (Digital Signal Processor), a ROM and a RAM, for example. The audio output control unit 111 controls output of audio of content to the user according to the viewing state acquired from the viewing state determination unit 109. The audio output control unit 111 raises the volume of audio, lowers the volume of audio, or changes the sound quality of audio, for example. The audio output control unit 111 may also control output depending on the type of audio, for example, by raising the volume of a vocal sound included in the audio. Further, the audio output control unit 111 may also control output of audio according to the importance of each part of content acquired from the importance determination unit 119. Furthermore, the audio output control unit 111 may use the user ID that the image processing unit 103 has acquired and refers to attribute information of the user that is registered in a ROM, a RAM, a storage device or the like in advance, to thereby control output of audio according to a preference of the user registered as the attribute information. The audio output control unit 111 provides control information of audio output to the audio output unit 113.

The audio output unit 113 is realized by a CPU, a DSP, a ROM and a RAM, for example. The audio output unit 113 outputs audio of content to the speaker 12 of the display device 10 according to the control information acquired from the audio output control unit 111. Additionally, audio data of content which is to be output is provided to the audio output unit 113 by a structure for content playback that is not shown in the drawing.

The content acquisition unit 115 is realized by a CPU, a ROM, a RAM and a communication device, for example. The content acquisition unit 115 acquires content to be provided to the user U by the display device 10. The content acquisition unit 115 may acquire broadcast content by demodulating and decoding broadcast wave received by an antenna, for example. The content acquisition unit 115 may also download content from a communication network via a communication device. Furthermore, the content acquisition unit 115 may read out content stored in a storage device. The content acquisition unit 115 provides video data and audio data of content which has been acquired to the content analysis unit 117.

The content analysis unit 117 is realized by a CPU, a ROM and a RAM, for example. The content analysis unit 117 analyses the video data and the audio data of content acquired from the content acquisition unit 115, and detects a keyword included in the content or a scene in the content. The content acquisition unit 115 uses the user ID acquired from the image processing unit 103 and refers to the attribute information of the user that is registered in advance, and thereby detects a keyword or a scene that the user U is highly interested in. The content analysis unit 117 provides these pieces of information to the importance determination unit 119. Additionally, a detailed functional configuration of the content analysis unit 117 will be described later.

The content information storage unit 151 is realized by a ROM, a RAM and a storage device, for example. Content information such as a EPG or an ECG is stored in the content information storage unit 151, for example. The content information may be acquired by the content acquisition unit 115 together with the content and stored in the content information storage unit 151, for example.

The importance determination unit 119 is realized by a CPU, a ROM and a RAM, for example. The importance determination unit 119 determines the importance of each part of content. The importance determination unit 119, for example, determines the importance of each part of content based on the information, acquired from the content analysis unit 117, on a keyword or a scene in which the user is highly interested. In this case, the importance determination unit 119 determines that a part of content from which the keyword or the scene is detected is important. The importance determination unit 119 may also determine the importance of each part of content based on the content information acquired from the content information storage unit 151. In this case, the importance determination unit 119 uses the user ID acquired by the image processing unit 103 and refers to the attribute information of the user that is registered in advance, and thereby determines that a part of content which matches the preference of the user registered as the attribute information is important. The importance determination unit 119 may also determine that a part in which a user is generally interested, regardless of which user, such as a part, indicated by the content information, at which a commercial ends and main content starts is important.

(Details of Image Processing Unit)

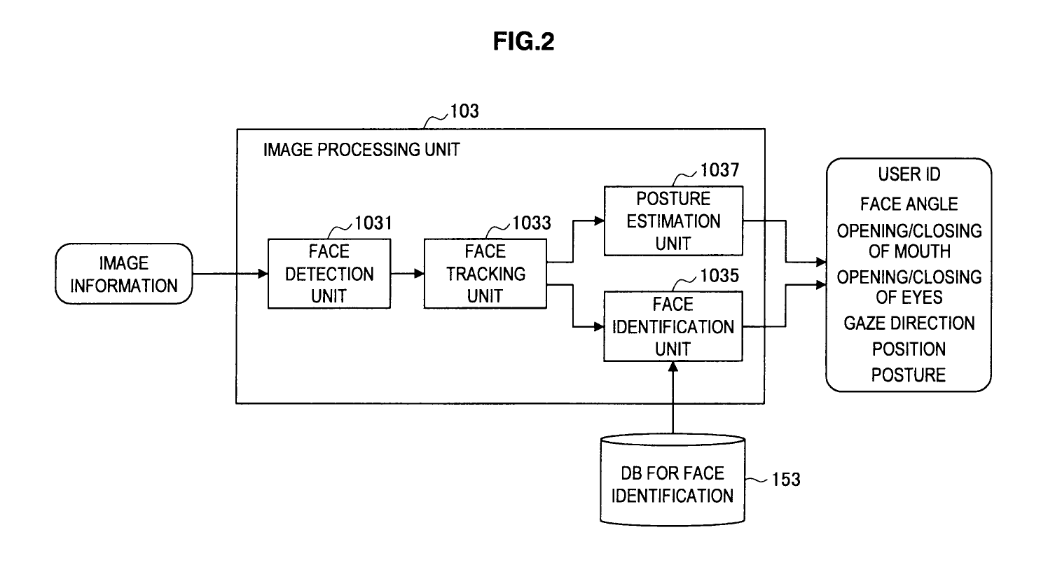

Next, a functional configuration of the image processing unit 103 of the information processing apparatus 100 will be further described with reference to FIG. 2. FIG. 2 is a block diagram showing a functional configuration of the image processing unit 103.

The image processing unit 103 includes a face detection unit 1031, a face tracking unit 1033, a face identification unit 1035 and a posture estimation unit 1037. The face identification unit 1035 refers to a DB 153 for face identification. The image processing unit 103 acquires image data from the image acquisition unit 101. Also, the image processing unit 103 provides, to the viewing state determination unit 109 or the content analysis unit 117, a user ID for identifying a user and information such as the angle of the face, opening and closing of the mouth, opening and closing of the eyes, the gaze direction, the position, the posture and the like.

The face detection unit 1031 is realized by a CPU, a GPU, a ROM and a RAM, for example. The face detection unit 1031 refers to the image data acquired from the image acquisition unit 101, and detects a face of a person included in the image. If a face is included in the image, the face detection unit 1031 detects the position, the size or the like of the face. Furthermore, the face detection unit 1031 detects the state of the face shown in the image. For example, the face detection unit 1031 detects a state such as the angle of the face, whether the eyes are closed or not, or the gaze direction. Additionally, any known technology, such as those described in JP 2007-65766A and JP 2005-44330A, can be applied to the processing of the face detection unit 1031.

The face tracking unit 1033 is realized by a CPU, a GPU, a ROM and a RAM, for example. The face tracking unit 1033 tracks the face detected by the face detection unit 1031 over pieces of image data of different frames acquired from the image acquisition unit 101. The face tracking unit 1033 uses similarity or the like between patterns of the pieces of image data of the face detected by the face detection unit 1031, and searches for a portion corresponding to the face in a following frame. By this processing of the face tracking unit 1033, faces included in images of a plurality of frames can be recognized as a change over time of the face of a same user.

The face identification unit 1035 is realized by a CPU, a GPU, a ROM and a RAM, for example. The face identification unit 1035 is a processing unit for performing identification as to which user's face a face detected by the face detection unit 1031 is. The face identification unit 1035 calculates a local feature by focusing on a characteristic portion or the like of the face detected by the face detection unit 1031 and compares the local feature which has been calculated and a local feature of a face image of a user stored in advance in the DB 153 for face identification, and thereby identifies the face detected by the face detection unit 1031 and specifies the user ID of the user corresponding to the face. Additionally, any know technology, such as those described in JP 2007-65766A and JP 2005-44330A, can be applied to the processing of the face identification unit 1035.

The posture estimation unit 1037 is realized by a CPU, a GPU, a ROM and a RAM, for example. The posture estimation unit 1037 refers to the image data acquired from the image acquisition unit 101, and estimates the posture of a user included in the image. The posture estimation unit 1037 estimates what kind of posture the posture of a user included in the image is, based on the characteristic of an image for each kind of posture of a user that is registered in advance or the like. For example, in a case a posture of a user holding an appliance close to the ear is perceived from the image, the posture estimation unit 1037 estimates that it is a posture of a user who is on the phone. Additionally, any known technology can be applied to the processing of the posture estimation unit 1037.

The DB 153 for face identification is realized by a ROM, a RAM and a storage device, for example. A local feature of a face image of a user is stored in advance in the DB 153 for face identification in association with a user ID, for example. The local feature of a face image of a user stored in the DB 153 for face identification is referred to by the face identification unit 1035.

(Details of Sound Processing Unit)

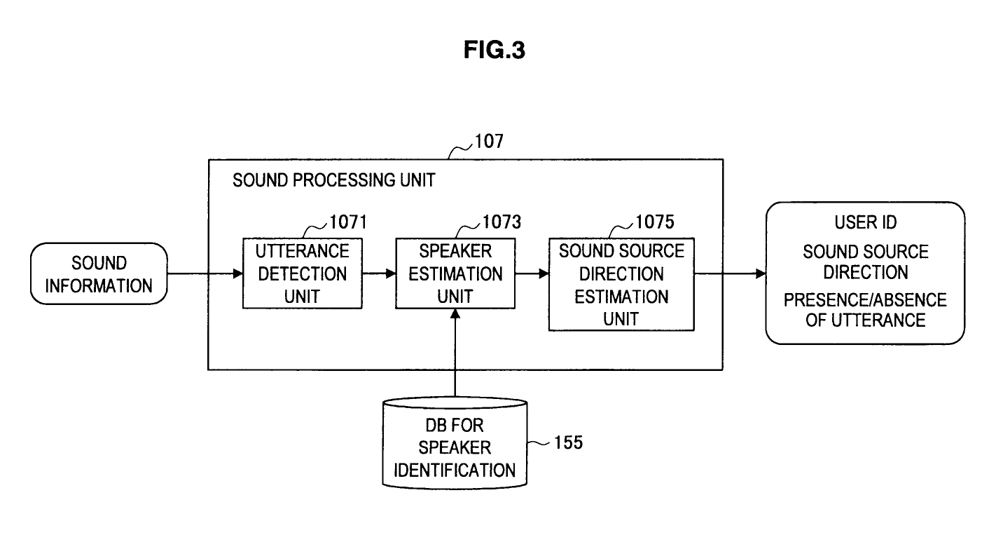

Next, a functional configuration of the sound processing unit 107 of the information processing apparatus 100 will be described with reference to FIG. 3.

FIG. 3 is a block diagram showing a functional configuration of the sound processing unit 107.

The sound processing unit 107 includes an utterance detection unit 1071, a speaker estimation unit 1073 and a sound source direction estimation unit 1075. The speaker estimation unit 1073 refers to a DB 155 for speaker identification. The sound processing unit 107 acquires sound data from the sound acquisition unit 105. Also, the sound processing unit 107 provides, to the viewing state determination unit 109, a user ID for identifying a user and information on a sound source direction, presence/absence of an utterance or the like.

The utterance detection unit 1071 is realized by a CPU, a ROM and a RAM, for example. The utterance detection unit 1071 refers to the sound data acquired from the sound acquisition unit 105, and detects an utterance included in the sound. In the case an utterance is included in the sound, the utterance detection unit 1071 detects the starting point of the utterance, the end point thereof, frequency characteristics and the like. Additionally, any known technology can be applied to the processing of the utterance detection unit 1071.

The speaker estimation unit 1073 is realized by a CPU, a ROM and a RAM, for example. The speaker estimation unit 1073 estimates a speaker of the utterance detected by the utterance detection unit 1071. The speaker estimation unit 1073 estimates a speaker of the utterance detected by the utterance detection unit 1071 and specifies the user ID of the speaker by, for example, comparing the frequency characteristics of the utterance detected by the utterance detection unit 1071 with characteristics of an utterance of a user registered in advance in the DB 155 for speaker identification. Additionally, any known technology can be applied to the processing of the speaker estimation unit 1073.

The sound source direction estimation unit 1075 is realized by a CPU, a ROM and a RAM, for example. The sound source direction estimation unit 1075 estimates the direction of the sound source of a sound such as an utterance included in sound data by, for example, detecting the phase difference of the sound data that the sound acquisition unit 105 acquired from a plurality of microphones 30 at different positions. The direction of sound source estimated by the sound source direction estimation unit 1075 may be associated with the position of a user detected by the image processing unit 103, and the speaker of the utterance may be thereby estimated. Additionally, any known technology can be applied to the processing of the sound source direction estimation unit 1075.

The DB 155 for speaker identification is realized by a ROM, a RAM and a storage device, for example. Characteristics, such as the frequency characteristics of an utterance of a user, are stored in the DB 155 for speaker identification in association with a user ID, for example. The characteristics of an utterance of a user stored in the DB 155 for speaker identification are referred to by the speaker estimation unit 1073.

(Details of Content Analysis Unit)

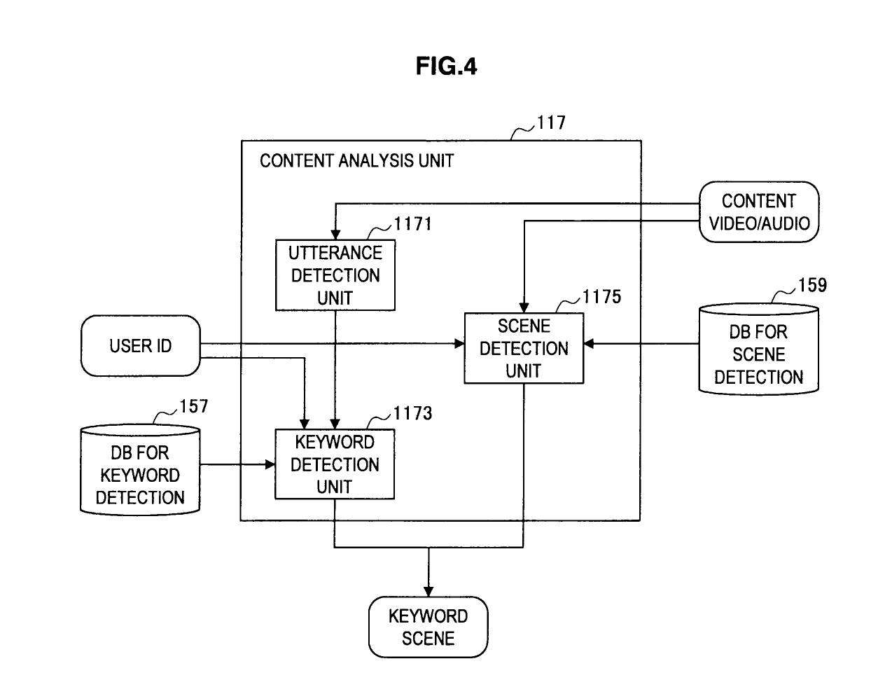

Next, a functional configuration of the content analysis unit 117 of the information processing apparatus 100 will be further described with reference to FIG. 4. FIG. 4 is a block diagram showing a functional configuration of the content analysis unit 117.

The content analysis unit 117 includes an utterance detection unit 1171, a keyword detection unit 1173 and a scene detection unit 1175. The keyword detection unit 1173 refers to a DB 157 for keyword detection. The scene detection unit 1175 refers to a DB 159 for scene detection. The content analysis unit 117 acquires a user ID from the image processing unit 103. Also, the content analysis unit 117 acquires video data and audio data of content from the content acquisition unit 115. The content analysis unit 117 provides information on a keyword or a scene for which the interest of a user is estimated to be high to the importance determination unit 119.

The utterance detection unit 1171 is realized by a CPU, a ROM and a RAM, for example. The utterance detection unit 1171 refers to the audio data of content acquired from the content acquisition unit 115, and detects an utterance included in the sound. In the case an utterance is included in the sound, the utterance detection unit 1171 detects the starting point of the utterance, the end point thereof, frequency characteristics and the like. Additionally, any known technology can be applied to the processing of the utterance detection unit 1171.

The keyword detection unit 1173 is realized by a CPU, a ROM and a RAM, for example. The keyword detection unit 1173 detects, for an utterance detected by the utterance detection unit 1171, a keyword included in the utterance. Keywords are stored in advance in the DB 157 for keyword detection as keywords in which respective users are highly interested. The keyword detection unit 1173 searches, in a section of the utterance detected by the utterance detection unit 1171, a part with audio characteristics of a keyword stored in the DB 157 for keyword detection. To decide which user's keyword of interest to detect, the keyword detection unit 1173 uses the user ID acquired from the image processing unit 103. In a case a keyword is detected in the utterance section, the keyword detection unit 1173 outputs, in association with each other, the detected keyword and the user ID of the user who is highly interested in this keyword, for example.

The scene detection unit 1175 is realized by a CPU, a ROM and a RAM, for example. The scene detection unit 1175 refers to the video data and the audio data of content acquired from the content acquisition unit 115, and detects a scene of the content. Scenes are stored in advance in the DB 159 for scene detection as scenes in which respective users are highly interested. The scene detection unit 1175 determines whether or not the video or the audio of content has the video or audio characteristics of a scene stored in the DB 159 for scene detection. To decide which user's scene of interest to detect, the scene detection unit 1175 uses the user ID acquired from the image processing unit 103. In a case a scene is detected, the scene detection unit 1175 outputs, in association with each other, the detected scene and the user ID of the user who is highly interested in this scene.

The DB 157 for keyword detection is realized by a ROM, a RAM and a storage device, for example. Audio characteristics of a keyword in which a user is highly interested are stored in advance in the DB 157 for keyword detection in association with a user ID and information for identifying the keyword, for example. The audio characteristics of keywords stored in the DB 157 for keyword detection are referred to by the keyword detection unit 1173.

The DB 159 for scene detection is realized by a ROM, a RAM, and a storage device, for example. Video or audio characteristics of a scene in which a user is highly interested are stored in advance in the DB 159 for scene detection in association with a user ID and information for identifying the scene, for example. The video or audio characteristics of a scene stored in the DB 159 for scene detection are referred to by the scene detection unit 1175.

(2. Process Flow)

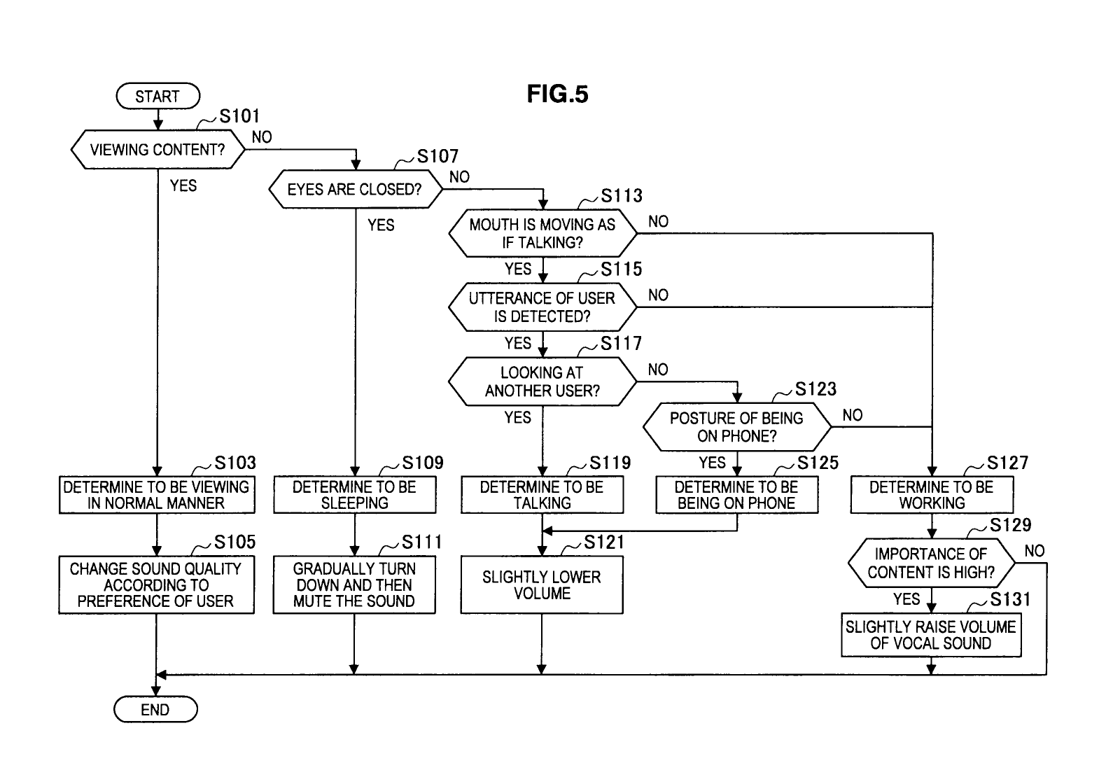

Next, a process flow of an embodiment of the present disclosure will be described with reference to FIG. 5. FIG. 5 is a flow chart showing an example of processing of the viewing state determination unit 109, the audio output control unit 111 and the importance determination unit 119 of an embodiment of the present disclosure.

Referring to FIG. 5, first, the viewing state determination unit 109 determines whether or not a user U is viewing video of content (step S101). Here, whether the user U1 is viewing the video of content or not may be determined based on the angle of the face of the user U, opening and closing of the eyes and gaze direction detected by the image processing unit 103. For example, in the case the angle of the face and the gaze direction of the user are close to the direction of the display unit 11 of the display device 10 or in the case the eyes of the user are not closed, the viewing state determination unit 109 determines that the “user is viewing content.” In the case there are a plurality of users U, the viewing state determination unit 109 may determine that the “user is viewing content,” if it is determined that one of the users U is viewing the video of content.

In the case it is determined in step S101 that the “user is viewing content,” the viewing state determination unit 109 next determines that the viewing state of the user of the content is “viewing in normal manner” (step S103). Here, the viewing state determination unit 109 provides information indicating that the viewing state is “viewing in normal manner” to the audio output control unit 111.

Next, the audio output control unit 111 changes the quality of audio of the content according to the preference of the user (step S105). Here, the audio output control unit 111 may refer to attribute information of the user that is registered in advance in a ROM, a RAM, a storage device and the like by using a user ID that the image processing unit 103 has acquired, and may acquire the preference of the user that is registered as the attribute information.

On the other hand, in the case it is not determined in step S101 that the “user is viewing content,” the viewing state determination unit 109 next determines whether the eyes of the user U are closed or not (step S107). Here, whether the eyes of the user U are closed or not may be determined based on the change over time of opening and closing of the eyes of the user U detected by the image processing unit 103. For example, in the case a state where the eyes of the user are closed continues for a predetermined time or more, the viewing state determination unit 109 determines that the “user is keeping eyes closed.” In the case there are a plurality of users U, the viewing state determination unit 109 may determined that the “user is keeping eyes closed,” if it is determined that both of the users U are keeping their eyes closed.

In the case it is determined in step S107 that the “user is keeping eyes closed,” the viewing state determination unit 109 next determines that the viewing state of the user of the content is “sleeping” (step S109). Here, the viewing state determination unit 109 provides information indicating that the viewing state is “sleeping” to the audio output control unit 111.

Next, the audio output control unit 111 gradually lowers the volume of audio of the content, and then mutes the audio (step S111). For example, if the user is sleeping, such control of audio output can prevent disturbance of sleep. At this time, video output control of lowering the brightness of video displayed on the display unit 11 and then erasing the screen may be performed together with the audio output control. If the viewing state of the user changes or an operation of the user on the display device 10 is acquired while the volume is being gradually lowered, the control of lowering the volume may be cancelled.

Here, as a modified example of the process of step S111, the audio output control unit 111 may raise the volume of the audio of content. For example, if the user is sleeping although he/she wants to view the content, such control of audio output can cause the user to resume viewing the content.

On the other hand, in the case it is not determined in step S107 that the “user is keeping eyes closed,” the viewing state determination unit 109 next determines whether or not the mouth of the user U is moving as if engaged in conversation (step S113). Here, whether or not the mouth of the user U is moving as if engaged in conversation may be determined based on the change over time of opening and closing of the mouth of the user U detected by the image processing unit 103. For example, in the case a state where the mouth of the user changes between open and close continues for a predetermined time or more, the viewing state determination unit 109 determines that the “mouth of the user is moving as if engaged in conversation.” In the case there are a plurality of users U, the viewing state determination unit 109 may determine that the “mouth of the user is moving as if engaged in conversation,” if the mouth of one of the users U is moving as if engaged in conversation.

In the case it is determined in step S113 that the “mouth of the user is moving as if engaged in conversation,” the viewing state determination unit 109 next determines whether an utterance of the user U is detected or not (step S115). Here, whether an utterance of the user U is detected or not may be determined based on the user ID of the speaker of an utterance detected by the sound processing unit 107. For example, in the case the user ID acquired from the image processing unit 103 matches the user ID of the speaker of an utterance acquired from the sound processing unit 107, the viewing state determination unit 109 determines that an “utterance of the user is detected.” In the case there are a plurality of users U, the viewing state determination unit 109 may determined that an “utterance of the user is detected,” if an utterance of one of the users U is detected.

In the case it is determined in step S115 that an “utterance of the user is detected,” the viewing state determination unit 109 next determines whether or not the user U is looking at another user (step S117). Here, whether or not the user U is looking at another user may be determined based on the angle of the face of the user U and the position detected by the image processing unit 103. For example, the viewing state determination unit 109 determines that the “user is looking at another user,” if the direction the user is facing that is indicated by the angle of the face of the user corresponds with the position of the other user.

In the case it is determined in step S117 that the “user is looking at another user,” the viewing state determination unit 109 next determines that the viewing state, of the user, of the content is “engaged in conversation” (step S119). Here, the viewing state determination unit 109 provides information indicating that the viewing state is “engaged in conversation” to the audio output control unit 111.

Next, the audio output control unit 111 slightly lowers the volume of the audio of the content (step S121). Such control of audio output can prevent disturbance of conversation when the user is engaged in conversation, for example.

On the other hand, in the case it is not determined in step S117 that the “user is looking at another user,” the viewing state determination unit 109 next determines whether or not the user U is taking a posture of being on the phone (step S123). Here, whether or not the user U is taking a posture of being on the phone may be determined based on the posture of the user U detected by the image processing unit 103. For example, in the case the posture estimation unit 1037 included in the image processing unit 103 estimated the posture of the user holding an appliance (a telephone receiver) close to the ear to be the posture of the user on the phone, the viewing state determination unit 109 determines that the “user is taking a posture of being on the phone.”

In the case it is determined in step S123 that the “user is taking a posture of being on the phone,” the viewing state determination unit 109 next determines that the viewing state, of the user, of the content is being “on the phone” (step S125). Here, the viewing state determination unit 109 provides information indicating that the viewing state is being “on the phone” to the audio output control unit 111.

Next, the audio output control unit 111 slightly lowers the volume of the audio of the content (step S121). Such control of audio output can prevent phone call from being interrupted in the case the user is on the phone, for example.

On the other hand, in the case it is not determined in step S113 that the “mouth of the user is moving as if engaged in conversation,” in the case it is not determined in step S115 that an “utterance of the user is detected” and in the case it is not determined in step S123 that the “user is taking a posture of being on the phone,” the viewing state determination unit 109 next determines that the viewing state, of the user, of the content is “working” (step S127).

Next, the importance determination unit 119 determines whether the importance of the content that is being provided to the user U is high or not (step S129). Here, whether the importance of the content that is being provided is high or not may be determined based on the importance of each part of the content determined by the importance determination unit 119. For example, the importance determination unit 119 determines that the importance of a part of the content from which a keyword or a scene that the user is highly interested in is detected by the content analysis unit 117 is high. Also, the importance determination unit 119 determines, based on the content information acquired from the content information storage unit 151, that the importance of a part of the content that matches the preference of the user that is registered in advance is high or that the importance of a part for which interest is generally high, such as a part at which a commercial ends and main content starts, is high, for example.

In the case it is determined in step S129 that the importance of the content is high, the audio output control unit 111 next slightly raises the volume of a vocal sound in the audio of the content (step S131). Such control of audio output can let the user know that a part, of the content, estimated to be of interest to the user has started, in a case the user is doing something other than viewing of the content, such as reading, doing household chores or studying, near the display device 10, for example.

(3. Hardware Configuration)

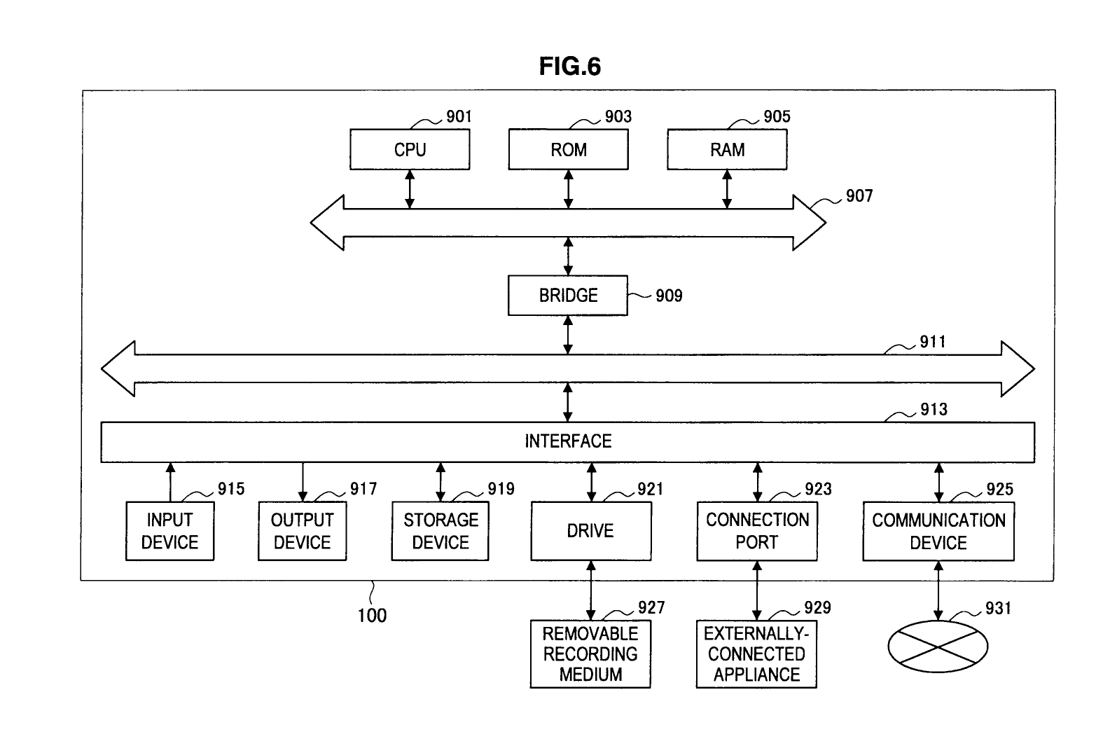

Next, a hardware configuration of the information processing apparatus 100 according to an embodiment of the present disclosure described above will be described in detail with reference to FIG. 6. FIG. 6 is a block diagram for describing a hardware configuration of the information processing apparatus 100 according to an embodiment of the present disclosure.

The information processing apparatus 100 includes a CPU 901, a ROM 903, and a RAM 905. Furthermore, the information processing apparatus 100 may also include a host bus 907, a bridge 909, and external bus 911, an interface 913, an input device 915, an output device 917, a storage device 919, a drive 921, a connection port 923, and a communication device 925.

The CPU 901 functions as a processing device and a control device, and controls the overall operation or a part of the operation of the information processing apparatus 100 according to various programs recorded in the ROM 903, the RAM 905, the storage device 919 or a removable recording medium 927. The ROM 903 stores programs to be used by the CPU 901, processing parameters and the like. The RAM 905 temporarily stores programs to be used in the execution of the CPU 901, parameters that vary in the execution, and the like. The CPU 901, the ROM 903 and the RAM 905 are connected to one another through the host bus 907 configured by an internal bus such as a CPU bus.

The host bus 907 is connected to the external bus 911 such as a PCI (Peripheral Component Interconnect/Interface) bus via the bridge 909.

The input device 915 is input means to be operated by a user, such as a mouse, a keyboard, a touch panel, a button, a switch, a lever or the like. Further, the input device 915 may be remote control means that uses an infrared or another radio wave, or it may be an externally-connected appliance 929 such as a mobile phone, a PDA or the like conforming to the operation of the information processing apparatus 100. Furthermore, the input device 915 is configured from an input control circuit or the like for generating an input signal based on information input by a user with the operation means described above and outputting the signal to the CPU 901. A user of the information processing apparatus 100 can input various kinds of data to the information processing apparatus 100 or instruct the information processing apparatus 100 to perform processing, by operating the input device 915.

The output device 917 is configured from a device that is capable of visually or auditorily notifying a user of acquired information. Examples of such device include a display device such as a CRT display device, a liquid crystal display device, a plasma display device, an EL display device or a lamp, an audio output device such as a speaker or a headphone, a printer, a mobile phone, a facsimile and the like. The output device 917 outputs results obtained by various processes performed by the information processing apparatus 100, for example. To be specific, the display device displays, in the form of text or image, results obtained by various processes performed by the information processing apparatus 100. On the other hand, the audio output device converts an audio signal such as reproduced audio data or acoustic data into an analogue signal, and outputs the analogue signal.

The storage device 919 is a device for storing data configured as an example of a storage unit of the information processing apparatus 100. The storage device 919 is configured from, for example, a magnetic storage device such as a HDD (Hard Disk Drive), a semiconductor storage device, an optical storage device, or a magneto-optical storage device. This storage device 919 stores programs to be executed by the CPU 901, various types of data, and various types of data obtained from the outside, for example.

The drive 921 is a reader/writer for a recording medium, and is incorporated in or attached externally to the information processing apparatus 100. The drive 921 reads information recorded in the attached removable recording medium 927 such as a magnetic disk, an optical disk, a magneto-optical disk, or a semiconductor memory, and outputs the information to the RAM 905. Furthermore, the drive 921 can write in the attached removable recording medium 927 such as a magnetic disk, an optical disk, a magneto-optical disk, or a semiconductor memory. The removable recording medium 927 is, for example, a DVD medium, an HD-DVD medium, or a Blu-ray (registered trademark) medium. The removable recording medium 927 may be a CompactFlash (CF; registered trademark), a flash memory, an SD memory card (Secure Digital Memory Card), or the like. Alternatively, the removable recording medium 927 may be, for example, an electronic appliance or an IC card (Integrated Circuit Card) equipped with a non-contact IC chip.

The connection port 923 is a port for allowing devices to directly connect to the information processing apparatus 100. Examples of the connection port 923 include a USB (Universal Serial Bus) port, an IEEE 1394 port, a SCSI (Small Computer System Interface) port, and the like. Other examples of the connection port 923 include an RS-232C port, an optical audio terminal, an HDMI (High-Definition Multimedia Interface) port, and the like. With the externally connected apparatus 929 connected to this connection port 923, the information processing apparatus 100 directly obtains various types of data from the externally connected apparatus 929, and provides various types of data to the externally connected apparatus 929.

The communication device 925 is a communication interface configured from, for example, a communication device for connecting to a communication network 931. The communication device 925 is, for example, a wired or wireless LAN (Local Area Network), a Bluetooth (registered trademark), a communication card for WUSB (Wireless USB), or the like. Alternatively, the communication device 925 may be a router for optical communication, a router for ADSL (Asymmetric Digital Subscriber Line), a modem for various communications, or the like. This communication device 925 can transmit and receive signals and the like in accordance with a predetermined protocol, such as TCP/IP, on the Internet and with other communication devices, for example. The communication network 931 connected to the communication device 925 is configured from a network or the like connected via wire or wirelessly, and may be, for example, the Internet, a home LAN, infrared communication, radio wave communication, satellite communication or the like.

Heretofore, an example of the hardware configuration of the information processing apparatus 100 has been shown. Each of the structural elements described above may be configured using a general-purpose material, or may be configured from hardware dedicated to the function of each structural element. Accordingly, the hardware configuration to be used can be changed as appropriate according to the technical level at the time of carrying out each of the embodiments described above.

(4. Summary)

According to an embodiment described above, there is provided an information processing apparatus which includes an image acquisition unit for acquiring an image of a user positioned near a display unit on which video of content is displayed, a viewing state determination unit for determining a viewing state, of the user, of the content based on the image, and an audio output control unit for controlling output of audio of the content to the user according to the viewing state.

In this case, output of audio of content can be controlled, more precisely meeting the needs of a user, by identifying states where the user is not listening to the audio of the content because of various reasons, for example.

Furthermore, the viewing state determination unit may determine, as the viewing state, whether the user is listening to the audio or not, based on opening/closing of eyes of the user detected from the image.

In this case, output of audio of content can be controlled by identifying a case where the user is asleep, for example. For example, in a case the user is asleep, the user's needs such as sleeping without being interrupted by the audio of content or awaking from sleep and resuming viewing of content are conceivable. In this case, control of output of audio of content, that more precisely meets such needs of the user, is enabled.

Furthermore, the viewing state determination unit may determine, as the viewing state, whether the user is listening to the audio or not, based on opening/closing of a mouth of the user detected from the image.

In this case, output of audio of content can be controlled by identifying a case where the user is engaged in conversation or is on the phone, for example. For example, in a case the user is engaged in conversation or is on the phone, the user's needs such as lowering the volume of audio of content because it is interrupting the conversation or the telephone call are conceivable. In this case, control of output of audio of content, that more precisely meets such needs of the user, is enabled.

The information processing apparatus may further include a sound acquisition unit for acquiring a sound uttered by the user. The viewing state determination unit may determine, as the viewing state, whether the user is listening to the audio or not, based on whether a speaker of an utterance included in the sound is the user or not.

In this case, the user can be prevented from being erroneously determined to be engaged in conversation or being on the phone, in a case where the user's mouth is opening and closing but a sound is not uttered, for example.

Furthermore, the viewing state determination unit may determine, as the viewing state, whether the user is listening to the audio or not, based on an orientation of the user detected from the image.

In this case, the user can be prevented from being erroneously determined to be engaged in conversation, in a case where the user is talking to himself/herself, for example.

Furthermore, the viewing state determination unit may determine, as the viewing state, whether the user is listening to the audio or not, based on a posture of the user detected from the image.

In this case, the user can be prevented from being erroneously determined to be on the phone, in a case where the user is talking to himself/herself, for example.

Furthermore, in a case it is determined, as the viewing state, that the user is not listening to the audio, the audio output control unit may lower volume of the audio.

In this case, output of audio of content can be controlled, reflecting the needs of the user, in a case where the user is sleeping, engaged in conversation or talking on the phone and is not listening to the audio of the content and therefore the audio of the content is unnecessary or is being a disturbance, for example.

Furthermore, in a case it is determined, as the viewing state, that the user is not listening to the audio, the audio output control unit may raise volume of the audio.

In this case, output of audio of content can be controlled, reflecting the needs of the user, in a case where the user is sleeping or working and is not listening to the audio of the content but has the intention of resuming viewing the content, for example.

Furthermore, the information processing apparatus may further include an importance determination unit for determining importance of each part of the content. The audio output control unit may raise the volume of the audio at a part of the content for which the importance is higher.

In this case, output of audio of content can be controlled, reflecting the needs of the user, in a case where the user wishes to resume viewing the content only at particularly important parts of the content, for example.

The information processing apparatus may further include a face identification unit for identifying the user based on a face included in the image. The importance determination unit may determine the importance based on an attribute of the identified user.

In this case, a user may be automatically identified based on an image, and also an important part of the content may be determined, reflecting the preference of the identified user, for example.

Furthermore, the information processing apparatus may further include a face identification unit for identifying the user based on a face included in the image. The viewing state determination unit may determine whether the user is viewing the video of the content or not, based on the image. In a case it is determined that the identified user is viewing the video, the audio output control unit may change a sound quality of the audio according to an attribute of the identified user.

In this case, output of audio of content that is in accordance with the preference of the user may be provided, in a case the user is viewing content, for example.

(5. Supplement)

In the above-described embodiment, “watching video,” “keeping eyes closed,” “mouth is moving as if engaged in conversation,” “uttering” and the like are cited as the examples of the movement of the user, and “viewing in normal manner,” “sleeping,” “engaged in conversation,” “on the phone,” “working” and the like are cited as the examples of the viewing state of the user, but the present technology is not limited to these examples. Various movements and viewing states of the user may be determined based on the acquired image and audio.

Also, in the above-described embodiment, the viewing state of the user is determined based on the image of the user and the sound that the user has uttered, but the present technology is not limited to this example. The sound that the user has uttered does not have to be used for determination of the viewing state, and the viewing state may be determined based solely on the image of the user.

Additionally, the present technology may also be configured as below.

(1) An information processing apparatus including:

an image acquisition unit for acquiring an image of a user positioned near a display unit on which video of content is displayed;

a viewing state determination unit for determining a viewing state, of the user, of the content based on the image; and

an audio output control unit for controlling output of audio of the content to the user according to the viewing state.

(2) The information processing apparatus according to (1) described above, wherein the viewing state determination unit determines, as the viewing state, whether the user is listening to the audio or not, based on opening/closing of eyes of the user detected from the image.
(3) The information processing apparatus according to (1) or (2) described above, wherein the viewing state determination unit determines, as the viewing state, whether the user is listening to the audio or not, based on opening/closing of a mouth of the user detected from the image.
(4) The information processing apparatus according to any one of (1) to (3) described above, further including:

a sound acquisition unit for acquiring a sound uttered by the user,

wherein the viewing state determination unit determines, as the viewing state, whether the user is listening to the audio or not, based on whether a speaker of an utterance included in the sound is the user or not.

(5) The information processing apparatus according to any one of (1) to (4) described above, wherein the viewing state determination unit determines, as the viewing state, whether the user is listening to the audio or not, based on an orientation of the user detected from the image.
(6) The information processing apparatus according to any one of (1) to (5) described above, wherein the viewing state determination unit determines, as the viewing state, whether the user is listening to the audio or not, based on a posture of the user detected from the image.
(7) The information processing apparatus according to any one of (1) to (6) described above, wherein, in a case it is determined, as the viewing state, that the user is not listening to the audio, the audio output control unit lowers volume of the audio.
(8) The information processing apparatus according to any one of (1) to (6) described above, wherein, in a case it is determined, as the viewing state, that the user is not listening to the audio, the audio output control unit raises volume of the audio.
(9) The information processing apparatus according to (8) described above, further including:

an importance determination unit for determining importance of each part of the content,

wherein the audio output control unit raises the volume of the audio at a part of the content for which the importance is higher.

(10) The information processing apparatus according to (9) described above, further including:

a face identification unit for identifying the user based on a face included in the image,

wherein the importance determination unit determines the importance based on an attribute of the identified user.

(11) The information processing apparatus according to any one of (1) to (10) described above, further including:

a face identification unit for identifying the user based on a face included in the image,

wherein the viewing state determination unit determines whether the user is viewing the video of the content or not, based on the image, and

wherein, in a case it is determined that the identified user is viewing the video, the audio output control unit changes a sound quality of the audio according to an attribute of the identified user.

(12) An information processing method including:

acquiring an image of a user positioned near a display unit on which video of content is displayed;

determining a viewing state, of the user, of the content based on the image; and

controlling output of audio of the content to the user according to the viewing state.

(13) A program for causing a computer to operate as:

an image acquisition unit for acquiring an image of a user positioned near a display unit on which video of content is displayed;

a viewing state determination unit for determining a viewing state, of the user, of the content based on the image; and

an audio output control unit for controlling output of audio of the content to the user according to the viewing state.

It should be understood by those skilled in the art that various modifications, combinations, sub-combinations and alterations may occur depending on design requirements and other factors insofar as they are within the scope of the appended claims or the equivalents thereof.

The present disclosure contains subject matter related to that disclosed in Japanese Priority Patent Application JP 2011-047892 filed in the Japan Patent Office on Mar. 4, 2011, the entire content of which is hereby incorporated by reference.

What is claimed is:

1. An information processing apparatus comprising:
an image acquisition unit for acquiring an image of a user positioned near a display unit on which video of content is displayed;
a viewing state determination unit for determining a viewing state, of the user, of the content based on the image; and
an audio output control unit for controlling output of audio of the content to the user according to the viewing state.

2. The information processing apparatus according to claim 1, wherein the viewing state determination unit determines, as the viewing state, whether the user is listening to the audio or not, based on opening/closing of eyes of the user detected from the image.

3. The information processing apparatus according to claim 1, wherein the viewing state determination unit determines, as the viewing state, whether the user is listening to the audio or not, based on opening/closing of a mouth of the user detected from the image.

4. The information processing apparatus according to claim 1, further comprising:
a sound acquisition unit for acquiring a sound uttered by the user,
wherein the viewing state determination unit determines, as the viewing state, whether the user is listening to the audio or not, based on whether a speaker of an utterance included in the sound is the user or not.

5. The information processing apparatus according to claim 1, wherein the viewing state determination unit determines, as the viewing state, whether the user is listening to the audio or not, based on an orientation of the user detected from the image.

6. The information processing apparatus according to claim 1, wherein the viewing state determination unit determines, as the viewing state, whether the user is listening to the audio or not, based on a posture of the user detected from the image.

7. The information processing apparatus according to claim 1, wherein, in a case it is determined, as the viewing state, that the user is not listening to the audio, the audio output control unit lowers volume of the audio.

8. The information processing apparatus according to claim 1, wherein, in a case it is determined, as the viewing state, that the user is not listening to the audio, the audio output control unit raises volume of the audio.

9. The information processing apparatus according to claim 8, further comprising:
an importance determination unit for determining importance of each part of the content,
wherein the audio output control unit raises the volume of the audio at a part of the content for which the importance is higher.

10. The information processing apparatus according to claim 9, further comprising:
a face identification unit for identifying the user based on a face included in the image,
wherein the importance determination unit determines the importance based on an attribute of the identified user.

11. The information processing apparatus according to claim 1, further comprising:
a face identification unit for identifying the user based on a face included in the image,
wherein the viewing state determination unit determines whether the user is viewing the video of the content or not, based on the image, and
wherein, in a case it is determined that the identified user is viewing the video, the audio output control unit changes a sound quality of the audio according to an attribute of the identified user.

12. An information processing method comprising:
acquiring an image of a user positioned near a display unit on which video of content is displayed;
determining a viewing state, of the user, of the content based on the image; and
controlling output of audio of the content to the user according to the viewing state.

13. A program for causing a computer to operate as:
an image acquisition unit for acquiring an image of a user positioned near a display unit on which video of content is displayed;
a viewing state determination unit for determining a viewing state, of the user, of the content based on the image; and
an audio output control unit for controlling output of audio of the content to the user according to the viewing state.
